(19) United States
(12) Patent Application Publication
(10) Pub. No.: US 2015/0006317 A1
(43) Pub. Date: Jan. 1, 2015

(54) PROGRAM MESSAGING SYSTEM

(71) Applicant: International Business Machines Corporation, Armonk, NY (US)

(72) Inventors: Stanley P. Cason, Johnson City, NY (US); Andrew Coleman, Vestal, NY (US); James R. Crossgrove, Owego, NY (US)

(21) Appl. No.: 13/932,592

(22) Filed: Jul. 1, 2013

(51) Int. Cl. G06Q 30/06; G06F 21/31

(52) U.S. Cl. CPC G06Q 30/0633; G06F 21/31
USPC 705/26.8

(57) ABSTRACT

A system for accessing a procurement application by means of a plug-in tool installed on an instant messaging system. The implementation of the plug-in allows a user to obtain information about a purchase order or shopping cart from within the messaging system without requiring user authentication by the procurement application.

### BACKGROUND OF THE INVENTION

### Field of the Invention

The invention relates to obtaining real time access to procurement data. More specifically, with an implementation of a plug-in, the invention allows users to obtain procurement data within a messaging system

### BRIEF SUMMARY OF THE INVENTION

### Description of the Related Art

In US Patent 20110252463A1, Yeleshwarapu describes a computer system that includes one or more processors and a computer-readable medium in communication with one or more processors. The computer system also includes an enterprise social network system, for retrieving and providing procurement information from a plurality of social network entities associated with the enterprise social network system.

In US Patent 20030033179, Katz describes a method for generating customized alerts related to the procurement, sourcing, strategic sourcing, and or sale of one or more items by an enterprise. The method is based on a Value Chain Intelligence System that enables suppliers and procurement professionals to leverage enterprise and marketplace data in order to potentially improve decision making in business enterprises.

In US Patent 20020065885, Buonanno describes a method and system for automatically handling exceptions in a business-to-business transaction. A unified communication system is then utilized to automatically contact and notify the representative of the exception.

In US Patent 20050108160, Vishik describes a line-by-line user interface enables a user to question individual line items in a transaction. The user interface provides multiple links to multiple destinations for multiple questions.

In US Patent 20100138310, Coleman describes a method and system for making a requisition for one or more items and monitoring the status of the order. When one or more orders are placed by a user of the module, an instant message or an e-mail is provided to the user to specify the status of the order to the user.

In foreign patent WO2006099046, Dillon describes a computer-implemented method in which a data set characterizing a first enterprise application is received.

The above patents, US and foreign, by Yeleshwarapu, Katz, Buonanna, Vishik, Coleman, and Dillon, shall be incorporated herein by reference in their entireties.

### BRIEF DESCRIPTION OF THE SEVERAL VIEWS OF THE DRAWINGS

FIG. 1 is a flowchart illustrating the basic operational steps of an embodiment of the present invention;

FIG. 2 is a diagram showing the tool used in implementing portions of the present invention;

FIG. 3 is a detailed diagram illustrating operation of the plug-in tool used with the present invention; and

FIG. 4 is a system of a computer hardware and software product for use in implementing portions of the present invention.

### DETAILED DESCRIPTION

For a better understanding of the present invention, together with other and further objects, advantages, and capabilities thereof, reference is made to the following disclosure and the appended claims in connection with the above-described drawings.

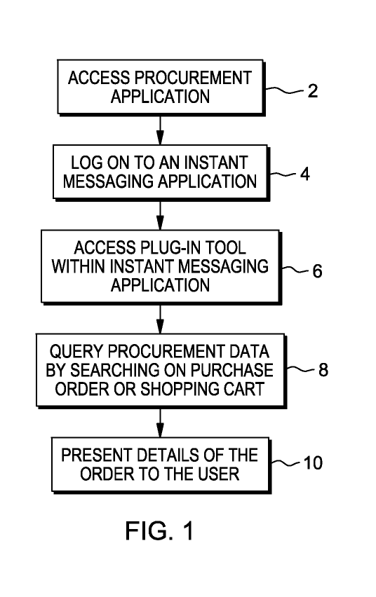

In FIG. 1, there is shown a flowchart depicting steps performed in practicing one embodiment of the invention.

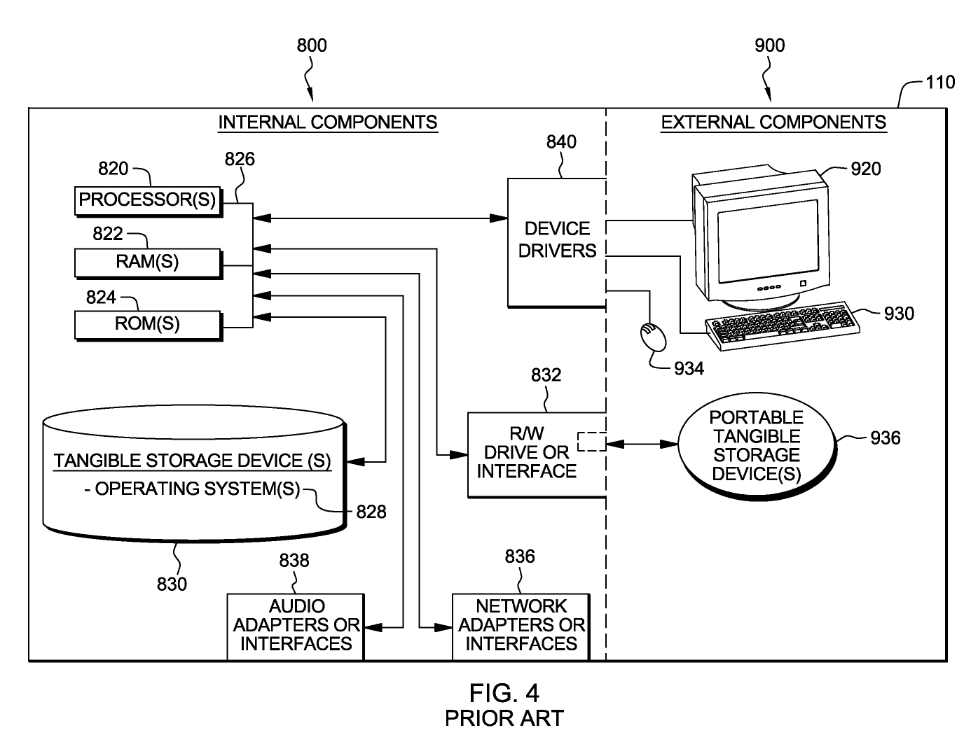

In step 2, a user access into a procurement application tied to a computer, such as the computer described in FIG. 4, wherein the procurement application contains purchase order and shopping cart data. The procurement application requires authentication of the user. However, the user does not authenticate during this step of the process. In some embodiments, the user may not be required to log on to a procurement application.

In step 4, a user logs on to an instant messaging system that provides a feature or ability to communicate with an outside application, such as a procurement application. The instant messaging application, for example, may be IBM Sametime® product. Sametime is a registered trademark of IBM Corporation of Armonk, N.Y. The instant messaging application requires authentication of the user. The user provides the authentication for the instant messaging application, in step 4.

In step 6, a plug-in tool is installed within the instant messaging system. The plug-in tool allows the user, without requiring authentication to access a procurement application for purchase order or shopping cart data. The plug-in uses the authentication provided by the user to the instant messaging application for accessing the procurement application. For example, there may exist a central authentic server within the instant messaging system, therefore, allowing authentication of the user without the procurement application accessing central server.

In step 8, a user searches for an order, within the instant messaging system, using either a purchase order or shopping cart number.

In step 10, if any details regarding the purchase order or shopping cart order can be found from the procurement application, then the details are retrieved and displayed to the user from the plug-in tool.

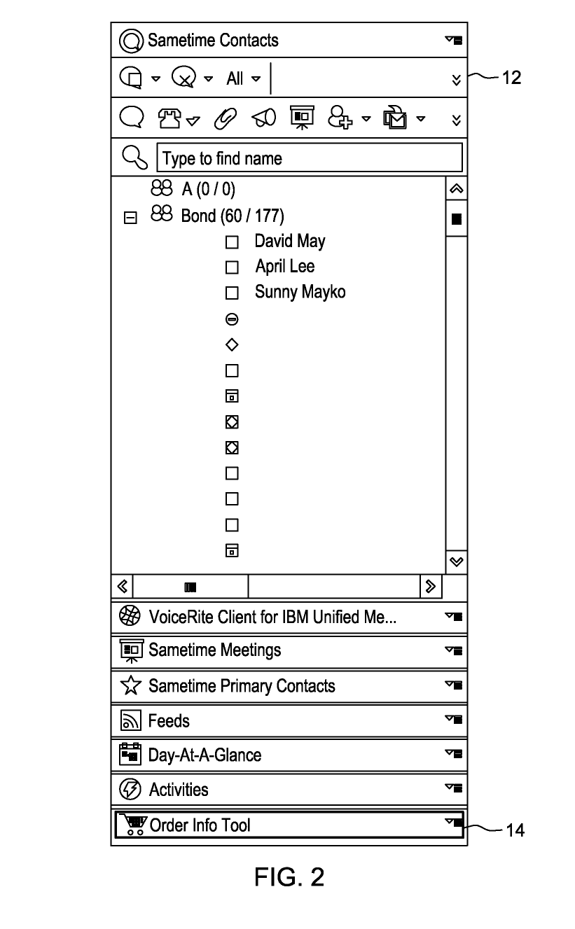

FIG. 2, illustrates an instant messaging system window 12, wherein the messaging system contains features, such as Sametime contacts and a plug-in tool 14, which is used in this invention. The plug-in tool is configured to access a procurement application without requiring user authentication by the procurement application as described above.

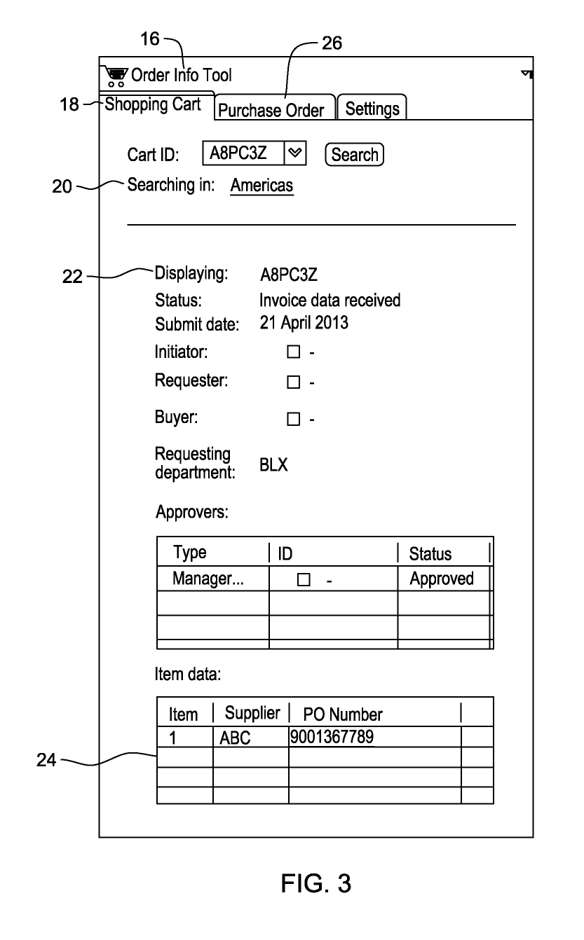

FIG. 3, illustrates the plug-in tool 16 when accessed by a user. The plug-in tool opens to the search criteria. The user selects either the search by shopping cart and enters the cart ID 18 or by purchase order 26. Searching begins 20 and if the order details are found, the details are displayed 22 to the user, listing such details as status of order, status of approvers, buyer information, and item data 24.

FIG. 4, shows a block diagram of internal components 800 and external components 900 of a computer 110, in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be based on design and implementation requirements.

Computer 110 is representative of any electronic device capable of executing machine-readable program instructions. Computer 110 may be representative of a computer system or other electronic devices. Examples of computing systems, environments, and/or configurations that may be represented by computer 110 include, but are not limited to, personal computer systems, server computer systems, thin clients, thick clients, laptop devices, smartphones, multiprocessor systems, microprocessor-based systems, network PCs, minicomputer systems, and distributed cloud computing environments that include any of the above systems or devices.

Computer 110 includes a set of internal components 800 and external components 900. Internal components 800 includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, functions in computer device 110 are stored on one or more of the respective computer-readable tangible storage devices 830 for execution by one or more of the respective processors 820 via one or more of the respective RAMs 822 (which typically include cache memory). In the embodiment illustrated in FIG. 2, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Internal components 800 also includes a R/W drive or interface 832 to read from and write to one or more portable computer-readable tangible storage devices 936, such as a CD-ROM, DVD, memory stick, magnetic tape, magnetic disk, optical disk or semiconductor storage device. Functions in computer 110 can be stored on one or more of the respective portable computer-readable tangible storage devices 936, read via the respective R/W drive or interface 832 and loaded into the respective hard drive 830.

Internal components 800 also includes audio adapters or interfaces 838 such as a sound card, hardware mixer, amplifier, or other adapters or interfaces for receiving audio signals from microphones.

Internal components 800 also includes network adapters or interfaces 836 such as a TCP/IP adapter cards, wireless wi-fi interface cards, or 3G or 4G wireless interface cards or other wired or wireless communication links. Functions in computer 110 can be downloaded to computer 110 from an external computer via a network (for example, the Internet, Cloud 24, a local area network or other, wide area network) and respective network adapters or interfaces 836. From the network adapters or interfaces 836. The network may comprise copper wires, optical fibers, wireless transmission, routers, firewalls, switches, gateway computers and/or edge servers.

External components 900 can include a computer display monitor 920, a keyboard 930, and a computer mouse 934. External components 900 can also include touch screens, virtual keyboards, touch pads, pointing devices, and other human interface devices. Internal components 800 includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Aspects of the present invention have been described with respect to block diagrams and/or flowchart illustrations of methods, apparatus (system), and computer program products according to embodiments of the invention. It will be understood that each block of the flowchart illustrations and/or block diagrams, and combinations of blocks in the flowchart illustrations and/or block diagrams, can be implemented by computer instructions. These computer instructions may be provided to a processor of a general purpose computer, special purpose computer, or other programmable data processing apparatus to produce a machine, such that instructions, which execute via the processor of the computer or other programmable data processing apparatus, create means for implementing the functions/acts specified in the flowchart and/or block diagram block or blocks.

The aforementioned programs can be written in any combination of one or more programming languages, including low-level, high-level, object-oriented or non object-oriented languages, such as Java, Smalltalk, C, and C++. The program code may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet service provider). Alternatively, the functions of the aforementioned programs can be implemented in whole or in part by computer circuits and other hardware (not shown).

The foregoing description of various embodiments of the present invention has been presented for purposes of illustration and description. It is not intended to be exhaustive or to limit the invention to the precise form disclosed. Many modifications and variations are possible. Such modifications and variations that may be apparent to a person skilled in the art of the invention are intended to be included within the scope of the invention as defined by the appended claims.

What is claimed is:

1. A system for accessing a procurement application, comprising:
a procurement application requiring authentication by a user, said procurement application having data regarding an order;
an instant messaging application requiring authentication having a plug-in tool installed, wherein said plug-in tool is configured to access said procurement application by making a connection and obtaining procurement authentication for said user via said instant messaging authentication;
and wherein,
said plug-in tool is configured to allow said user to query said data regarding said order in said procurement application.

2. The system of claim 1, wherein the system authenticates the user for access to the procurement application.

3. The system of claim 2, wherein the system application records purchase order and shopping cart data.

4. The system of claim 1, wherein the system authenticates the user for access to the instant messaging system.

5. The system of claim 4, wherein the system has the ability, via the plug-in tool installed on said instant messaging system, to interface with, said procurement application wherein said procurement application resides outside said instant messaging system.

6. The system of claim 5, wherein the system allows said user to query said purchase order and shopping cart data from within said instant messaging system.

7. The system of claim 6, wherein the system will retrieve and provide real time details of said order to said user.

8. A method for accessing a procurement application, comprising the steps of:
accessing said procurement application that contains procurement data, said procurement application requiring authentication by a user;
accessing an instant messaging application where a plug-in tool has been installed therein, and wherein said plug-in tool is configured to access said procurement application by making a connection and obtaining procurement authentication for said user via said instant messaging authentication;
searching said procurement data from within said messaging system; and
displaying results of said searching to said user.

9. The method of claim 8, wherein said data is a list of purchase order and shopping cart items.

10. The method of claim 9, wherein the plug-in tool allows said user to search for information regarding purchase order or shopping cart data.

11. The method of claim 10, wherein said user searches either by purchase order or cart.

12. The method of claim 11, wherein said data is retrieved from said procurement application and displayed to said user from within said instant messaging system.

13. A computer program product for a system of accessing a procurement application, said computer program product comprising:
a computer readable storage medium;
first program instructions for accessing said procurement application that contains procurement data, said procurement application requiring authentication by a user;
second program instructions for accessing an instant messaging application where a plug-in tool has been installed therein and wherein said plug-in tool is configured to access said procurement application by making a connection and obtaining procurement authentication for a user via instant messaging authentication;
third program instructions for searching said procurement data within said messaging system; and
fourth program instructions for displaying results of said searching to said user; and wherein,
all said program instructions means are recorded on said medium.
